(19) United States
(12) Patent Application Publication
(10) Pub. No.: US 2013/0142855 A1
(43) Pub. Date: Jun. 6, 2013

(54) MODIFIED SOPHOROLIPIDS COMBINATIONS AS ANTIMICROBIAL AGENTS

(71) Applicant: Polytechnic Institute of New York University, Brooklyn, NY (US)

(72) Inventors: Richard A. Gross, Plainview, NY (US); Thavasi Renga Thavasi, Ozone Park, NY (US)

(73) Assignee: Polytechnic Institute of New York University, Brooklyn, NY (US)

(21) Appl. No.: 13/757,762

(22) Filed: Feb. 2, 2013

Related U.S. Application Data
(63) Continuation-in-part of application No. 12/360,486, filed on Jan. 27, 2009.
Application No. 12/360,486 is a continuation of application No. 11/020,683, filed on Dec. 22, 2004, now abandoned.
Application No. 11/020,683 is a continuation-in-part of application No. 13/080,609, filed on Apr. 5, 2011.
Application No. 13/080,609 is a continuation-in-part of application No. 13/644,563, filed on Oct. 4, 2012.
(60) Provisional application No. 61/320,885, filed on Apr. 5, 2010.
(60) Provisional application No. 61/543,122, filed on Oct. 4, 2011.

(51) Int. Cl. A01N 43/16; A01N 43/90

(52) U.S. Cl. CPC A01N 43/16; A01N 43/90
USPC 424/408; 514/25; 424/405; 424/419; 424/418; 422/28

(57) ABSTRACT

A method to control, inhibit, and kill pathogens and normal microbial strains that includes, but not limited to plant, animal and human pathogens, biofilm forming microbes, biofouling microbes, algae, fungi, bacteria, virus and protozoa using natural SL, MSL derivative and combinations thereof encompassed by the combination invention.

### STATEMENT OF RELATED APPLICATIONS

This application is a continuation in part of and claims the benefit of U.S. patent application Ser. No. 12/360,486 filed on 27 Jan. 2009, which claims the benefit of U.S. patent application Ser. No. 11/020,683 filed on 22 Dec. 2004, which is the US National Phase of International Application No. PCT/US2003/035871 filed on 6 Nov. 2003; and of U.S. patent application Ser. No. 13/080,609 filed on 5 Apr. 2011, which claims the benefit of U.S. Provisional Patent Application No. 61/320,885 filed 5 Apr. 2010; and of U.S. patent application Ser. No. 13/644,563 filed on 4 Oct. 2012, which claims the benefit of U.S. Provisional Patent Application No. 61/543,122 filed on 4 Oct. 2011.

### BACKGROUND OF THE INVENTION

1. Technical Field

Use of modified sophorolipid combinations as antimicrobial agents to control pathogens and other microbial strains that includes, but is not limited to, plant, animal and human pathogens, biofilm forming microbes, biofouling microbes, algae, fungi, bacteria, virus and protozoa.

2. Prior Art

Sophorolipids (SL) are glycolipid biosurfactant molecules produced by yeasts, such as Candida bombicola, Yarrowi alipolytica, Candida apicola, and Candida bogoriensis. Microbial biosurfactants are surface active compounds produced by various microorganisms. They lower surface and interfacial tension and form spherical micelles at and above their critical micelle concentration (CMC). Microbial biosurfactants generally have an amphiphilic structure, possessing a hydrophilic moiety, such as an amino acid, peptide, sugar or oligosaccharide, and a hydrophobic moiety including saturated or unsaturated lipid or fatty acids.

SLs consist of a hydrophilic carbohydrate head, sophorose, and a hydrophobic fatty acid tail with generally 16 or 18 carbon atoms with saturation or un-saturation. Sophorose is an unusual disaccharide that consists of two glucose molecules linked β-1,2. Furthermore, sophorose in SLs can be acetylated on the 6′- and/or 6″-positions (FIG. 1). One fatty acid hydroxylated at the terminal or subterminal (β-1) positions is β-glycosidically linked to the sophorose molecule. The fatty acid carboxylic acid group is either free (acidic or open form) or internally esterified generally at the 4″-position (lactonic form) (FIG. 1). The hydroxy fatty acid component of SLs generally has 16 or 18 carbon atoms with generally one unsaturated bond (Asmer et al. 1988; Davila et al. 1993). However, the SL hydroxy fatty acid can also be fully saturated, di-unsaturated or tri-unsaturated. As such, SLs synthesized by C. bombicola consist of a mixture of related molecules. Differences between these molecules are found based on: i) the fatty acid structure (degree of unsaturation, chain length, and position of hydroxylation), whether they are produced in the lactonic or ring-opened form, and ii) the acetylation pattern.

Studies have been carried out to “tailor” SL structure during in vivo formation. These studies have mainly involved the selective feeding of different lipophilic substrates. For example, changing the co-substrate from sunflower to canola oil resulted in a large increase (50% to 73%) in the lactonic portion of SLs (Tulloch et al. 1962; Asmer et al. 1988; Davila et al. 1992; Zhou et al. 1992, 1995). Also, unsaturated C-18 fatty acids of oleic acid may be transferred unchanged into SLs (Rau et al. 1999). Finally, lactonic and acidic SLs are synthesized in vivo from stearic acid with similar yields to oleic acid-derived SLs (Felse et al. 2007). Thus, to date, physiological variables during fermentations have provided routes to the variation of SL compositions.

As noted above, fermentation by different microorganisms, Candida bombicola, Yarrowi alipolytica, Candida apicola, and Candida bogoriensis, leads to sophorolipids of different structure noted above, the variations in sophorolipids based on fatty acid feedstocks and organisms leads to a wide array of sophorolipids including lactonic and acidic structures. An additional modification that is relevant to acidic sophorolipids is cleavage of the sophorose moiety to the corresponding glucose-based glucolipids. Treatment of acidic sophorolipids with enzymes β-glucuronidase (Helix pomatia), cellulase (Penicillium funiculosum), Clara diastase (a mixture of enzymes including amylase, cellulase, peptidase, phosphatase, and sulphatase), galactomannanase (Aspergillus niger), hemicellulase (Aspergillus niger), hesperidinase (Aspergillus niger), inulinase (Aspergillus niger), pectolyase (Aspergillus japonicus), or naringinase (Penicillium decumbens) afford glucolipids over a range of pH values (Rau et al. 1999) (for enzymatic treatment of SLs, see Scheme 1).

In addition to tailoring SL in vivo formation, it is known that by chemical or enzymatic modification of SLs, their physical properties can be manipulated (Zhang et al., 2004). Modifications of SLs were performed so that the chain length of the n-alkyl group (methyl, ethyl, propyl, butyl, and hexyl) esterified to the SL fatty acid was varied. The effect of the n-alkyl ester chain length on interfacial properties of corresponding sophorolipid analogues was studied. The critical micelle concentration (CMC) and minimum surface tension have an inverse relationship with the alkyl ester chain length. That is, CMC decreased to ½ per additional CH₂ group for the methyl, ethyl, and propyl series of chain lengths. These results were confirmed by fluorescence spectroscopy. Adsorption of SL alkyl esters on hydrophilic solids was also studied to explore the type of lateral associations. These surfactants were found to absorb on alumina but much less on silica. This adsorption behavior on hydrophilic solids is similar to that of sugar-based nonionic surfactants and unlike that of nonionic ethoxylated surfactants. Hydrogen bonding is proposed to be the primary driving force for adsorption of the sophorolipids on alumina. Increase in the n-alkyl ester chain length of SLs caused a shift of the adsorption isotherms to lower concentrations. The magnitude of the shift corresponds to the change in cmc of these surfactants. This study suggests that by careful modulation of SL structure via simple chemical modification, dramatic shifts in their surface-activity can be achieved to ‘tune’ their properties for a desired interfacial challenge.

Yoo et al. (2005) reported that the sophorolipid natural mixture (non-chemically modified) is active against fungal plant pathogens Phytophthora sp. and Pythium sp. that are responsible for dumping-off disease. Inhibition of mycelial growth and zoospore motility was observed at high concentrations (200 mg/L and 50 mg/L, respectively). Thus, natural sophorolipids may be economically produced but have relative low activity against plant pathogen strains.

It has been shown that modified sophorolipids (MSLs) have antibacterial, antiviral, and anti-inflammatory properties (Mueller et al. 2006; Shah et al. 2005). In one example, MSLs were shown to down-regulate expression of pro-inflammatory cytokines including interleukin (Hagler et al. 2007). Furthermore, as shown in Table 1, the antibacterial activity of SLs can be increased by up to 1,000 times relative to the natural SL mixture by simple modifications such as esterification of fatty acid carboxyl groups and selective acetylation of disaccharide hydroxyl groups.

TABLE 1
Antibacterial activity of MSLs against human pathogens

| | Compound codes | | | | | |
|---|---|---|---|---|---|---|
| | 13 | 3 | 9 | 10 | 6 | 1 |
| Pathogens | Minimum Inhibitory Concentration 100 (MIC₁₀₀) in mg/mL | | | | | |
| Escherichia coli | 1.67 | 5 | 5 | 5 | 1.67 | 5 |
| Moraxella sp. | 1.67 | 5 | 2.05 × 10⁻² | 6.17 × 10⁻² | 6.17 × 10⁻² | 5 |
| Ralstonia eutropha | 5 | 5 | 5 | 5 | 5 | 5 |
| Rhodococcocus | N/A | 0.56 | 6.86 × 10⁻³ | 5 | 5 | 5 |
| erythropolis | | | | | | |
| Salmonella | 5 | 5 | 5 | 5 | 1.67 | 5 |
| choleraesuis | | | | | | |

Note:
All values in Table 1 are in mg/mL. “Natural SL”, compound 1, refers to the mixture of acidic and lactonic sophorolipids obtained from fermentation. Structures of natural and modified sophorolipids are shown in FIGS. 1, 6, 7, 8 and 9. MIC₁₀₀ means the minimum inhibition concentration at which 100% growth inhibition observed. Names of compounds discussed in this Table are given below.
6 open chain (or ring-opened) SL-methyl ester
9 open chain SL-ethyl ester, 6″-acetyl
10 open chain SL-ethyl ester, 6′,6″-diacetyl
13 open chain SL-ethyl ester, 6′-acetyl
3 open chain SL free acid
1 Natural sophorolipid mixture

Our previous work on antimicrobial activity of MSLs showed antimicrobial activity against plant pathogens that include fungi, bacteria and their spores at 0.15 to 10 mg/mL minimum inhibitory concentrations (MIC) (U.S. Provisional patent application Ser. Nos. 12/360,486; 61/320,885). Further, formulation of MSLs with Tween 20 and Polypropylene glycol increased the broad spectrum antimicrobial activity of SLs (U.S. Provisional Patent Application No. 61/543,122). However, in the current invention, while preparing MSL for formulation we noticed a surprising result, i.e., when we mix two modified SLs (e.g., compound 6 with 7) the compounds become completely soluble in distilled water without Tween 20 and polypropylene glycol, whereas they are not soluble separately/individually. These surprising results prompted us to explore whether the change in solubility upon mixing MSLs could potentially result in any other changes in properties of MSL for other applications. As part of answering this question, which potentially could involve many different properties of MSLs, we first focused on whether mixing MSLs would result in any beneficial changes in their antimicrobial activity. The results disclosed in the present patent application are surprising and nonobvious given that we had no reason to explore combinations of MSLs for antimicrobial applications other than the observation of a change in solubility by mixing these compounds. Furthermore, there is no prior art disclosing that mixtures of MSLs or mixtures of MSLs with natural sophorolipids could be beneficial to the property of antimicrobial activity.

Previous studies have been made on biopesticide activity of microbial and chemical biosurfactants. Correll et al. (2002) investigated several ionic and non-ionic chemical surfactants as well as fungicides azoxystrobin (Quadris) and 1,2,3-benzothiadiazole-7-carbothioic acid S-methyl ester (Actigard) in greenhouse and field tests. Indeed, several surfactants were shown to be highly effective in controlling white rust disease of spinach, caused by the Oomycete pathogen Albugo occidentalis. Several of these compounds are also effective on downy mildew of spinach, caused by the Oomycete pathogen Peronospora farinosa. These two pathogens are of greatest importance worldwide in protecting spinach crops.

Other researchers have studied the use of microbial biosurfactants as safe and effective biopesticides. For example, Stanghellini et al. (1996, 1997), while investigating control of root rot fungal infections on cucumbers and peppers caused by Pythium aphanidermatum and Phytophthora capsici, observed lysis of fungal zoospores. They postulated that cell lysis was due to a microbial surfactant in the nutrient solution. Subsequently, the bacterium was found to be Pseudomonas aeruginosa, a rhamnolipid biosurfactant producer. It was established that rhamnolipids have zoosporicidal activity against species of Pythium, Phytophora, and Plasmopara at concentrations ranging over 5 to 30 μg/mL. Rhamnolipids are believed to intercalate with and disrupt plasma membranes. Indeed, US EPA Presidential Green Chemistry Awards were recently presented to Agraquest Inc. and Jeneil Biosurfactant Companies for their work in developing rhamnolipid and lipopeptide biopesticide products, respectively. As mentioned above, rhamnolipids were found to be effective biopesticides and these results led to their commercialization by Jeneil Biosurfactants Co., LLC. However, the highest volumetric yields of rhamnolipids thus far reported is 45 g/L (Trummler et al., 2003), which is more than an order of magnitude lower than volumetric yields obtainable during sophorolipid fermentations (700 g/L) (Marchal et al., 1997). These facts, along with the phase separation of sophorolipids in fermentors which allows for their solvent-free isolation from fermentation broths, lead us to conclude that sophorolipids can be produced at lower costs than rhamnolipids.

US Patent Publication US2005/0266036 describes rhamnolipids, a glycolipid biosurfactant produced by Pseudomonas aeruginosa, displays pesticidal activity on account of their cell wall penetration effect. However, the patent application cited above, and other prior art quoted in this document, does not indicate in any way, and nor is it evident, that use of combinations of modified rhamnolipids would be beneficial for improving their antimicrobial activity.

Besides the antimicrobial activity reported for natural SLs and MSLs, US Patent Publication 2012/0220464 A1 describes that addition of natural SLs and MSLs in pesticide formulation has increased the performance of the pesticide as a adjuvant. The enhanced activity reported in US2012/0220464 A1 claims that when one active pesticidal ingredient such as Opus® or Cato® combined with a natural or an MSL adjuvant, an enhanced activity of the active pesticide ingredient is obtained. Hence, the discovery herein is unique, distinct and could not be anticipated from US201210220464 A1. The present patent application describes how large enhancements in activity are achieved by combining an MSL with one or more natural SLs, or an MSL is combined with a different MSL. The enhancements in antimicrobial activity observed herein are above what could be anticipated by one skilled in the art. See, also, WO 2003/043593 A1.

The novel method described herein that is termed the “combination invention” is that by: i) mixing two MSLs or mixing more than two MSLs, ii) mixing one MSL or more than one MSL with a SL component of the natural mixture, or iii) mixing one MSL or more than one MSL with one or more SL components of the natural mixture results in synergistic effects whereby the combination of compounds results in much higher activity of the additive contributions of each of the components alone to reduce the proliferation of pathogenic bacteria, fungi, their spores and normal microbial strains. Applications for this invention are broad and encompass the use of this “combination invention” as antimicrobials for environmental, industrial and medical fields.

### BRIEF SUMMARY OF THE INVENTION

The surprising and novel findings disclosed in this invention is that by: i) mixing two MSLs or mixing more than two MSLs, ii) mixing one MSL or more than one MSL with a SL component of the natural mixture, or iii) mixing one MSL or more than one MSL with one or more SL components of the natural mixture, the resulting antimicrobial activity is much greater than the additive effects of the components alone (the “combination invention”). Applications of the combination invention include but are not limited to the following: i) to kill or inhibit the growth of pathogens and normal microbial strains such as pathogens of plants, animals and humans; ii) biofilm forming microbes; and iii) bio-fouling microbes. Microbes that can be killed or inhibited by the “combination invention” include but are not limited to algae, fungi, bacteria, virus and protozoa. MSL derivatives disclosed herein are described based on the predominant fatty acid constituent, 17-hydroxyoleic acid, produced by C. bombicola when fed crude oleic acid as its fatty acid source. However, because changes in the lipid feed (canola oil and rapeseed oil) lead to different SLs as described above, variations in feedstock also will result in changes in composition of MSL structures that are disclosed herein.

The new combination invention for use with natural SLs and MSLs disclosed herein provides for unique compositions relative to known natural SL and MSL derivatives in previous art that were discovered to be highly effective against commercially important plant pathogens, human pathogens, animal pathogens and undesired environmental microorganisms. Currently, natural SLs may be economically produced but have relative low activity against pathogenic and normal microbes. The present invention discloses a solution to this problem that involves the discovery of combination of natural SLs and MSLs that enhance their activities against pathogenic microbes and normal microbial strains.

MSLs and natural SLs that are useful in this invention and thereby incorporated herein are shown in FIGS. 1 to 11, Scheme 1 and 2, and Table 2, whereby by mixing the compounds a surprisingly large boost in activity has been found, namely,

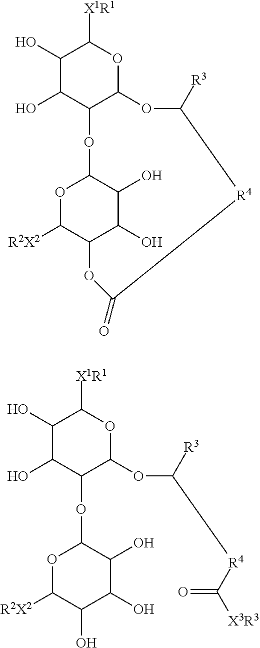

where X¹ =X² =CH₂

In one embodiment:
X¹ or X² can be oxymethyl (—CH₂O—) or methylene (—CH₂—);

R¹ and/or R² can be selected from the following functional groups: hydrogen, acetyl, acryl, urethane, hydroxyalkyl, ether, halide, carboxyalkyl or alkyl containing heteroatoms (1°, 2°, and 3° amino, tetraalkylammonium, sulfate, phosphate);
Alternatively, X¹ or X² can be carbonyl (—C═O—) and R¹ and/or R² can be selected from the following groups: hydroxyl, amide, alkanamide, alkanamide containing heteroatoms (1°, 2°, and 3° amino, tetraalkylammonium), alkylsulfate, alkylphosphate, carbohydrate, mono- or oligopeptide;
R³ can be a hydrogen or alkyl group;
R⁴ is an alkyl chain that normally has 15 carbons but can have between 9 and 19 carbons and normally has unsaturation (C═C bond) at one or more sites. Derivatives in this invention include modifying unsaturated (C═C) bonds within R⁴ to be saturated (by hydrogenation), epoxidized, hydroxylated (by hydrolysis of the epoxide or hydroboration oxidation or dihydroxylation using osmium tetroxide), or converted to a dithiirane, alkyl aziridine, cyclopropyl, thioalkane derivative. The methods involved in performing these chemical transformations are well known to those skilled in the art;
X³ can contain heteroatoms (e.g., O, S, NH); and
The combination of X³R³ can be selected from the following functional groups: hydroxy, alkanethiolate, amide, alkanamide, alkanamide containing heteroatoms (1°, 2°, and 3° amino, tetraalkylammonium), alkylsulfate, alkylphosphate, carbohydrate, mono- or oligopeptide with 2-50 amino acids.

### BRIEF DESCRIPTION OF THE FIGURES AND SCHEMES

FIG. 1 shows the structure of lactonic and open chain (acidic) forms of sophorolipid mixture produced by Candida bombicola.

FIG. 2 shows formulas for sophorolipids and sophorolipid analogs of the present invention.

FIG. 3 shows Sophorolipids in the lactonic form.

FIG. 4 shows Sophorolipids in the open chain (acidic) form.

FIG. 5 shows representative ester derivatives of the open chain form.

FIG. 6 shows amide and related derivatives of the open chain form.

FIG. 7 shows derivatives of the C═C (double bond) in the lactonic and open chain forms.

FIG. 8 shows derivatives in which the C═C (double bond) in the lactonic and open chain forms have been hydrogenated.

FIG. 9 shows peptide derivatives of the open chain form.

FIG. 10 shows trans alkylidenation derivatives of lactonic and open chain SLs.

FIG. 11 shows electrophile derivatives at sophorose ring.

Scheme 1 shows a summary of chemo-enzymatic chemistry developed to prepare a library of sophorolipid analogs (see Azim et al. 2006, Singh et al., 2003, Bisht et al, 2000, Bisht et al., 1999)

Scheme 2 shows a synthesis of diamide derivatives from lactonic sophorolipid using transalkylidenation followed by amidation reactions.

### DETAILED DESCRIPTION OF PREFERRED EMBODIMENTS

Embodiments of this invention are based on the discovery that by: i) mixing two MSLs or mixing more than two MSLs; ii) mixing one MSL or more than one MSL with a SL component of the natural mixture; iii) mixing one MSL or more than one MSL with one or more SL components of the natural mixture, such mixtures result in synergistic effects whereby the combination of compounds results in much higher activity then the additive contributions of each of the components alone to kill or inhibit the growth of pathogens such as pathogens of plants, animals and humans as well as normal bacteria that grow on surfaces (e.g. bio-fouling microbes). Microbes that can be killed or inhibited by the “combination invention” include but are not limited to algae, fungi, bacteria, virus and protozoa.

Modifications of SLs from their natural form were described in our earlier U.S. patent application Ser. Nos. 12/360,486, 61/320,885, 61/543,122, and their chemical formula and structure are described therein in detail.

Embodiments of this invention include formulation of MSLs, natural SLs and their combinations with inert ingredients as listed in EPA's eligible inert ingredients list (see, e.g., http://www.epa.gov/opprd001/inerts/section25b_inerts.pdf) and any other material that could be used as an inert ingredient in the future. MSL combinations described in this patent also include other MSL compositions that would be obvious to one skilled in the art based on review of this application or those encompassed within prior art.

This invention also incorporates additional variations in MSL structures beyond those disclosed previously that does not depart from the scope and spirit of the invention.

Results and Discussion

Natural SLs and MSLs suitable for use in this invention include the following chemical compositions.

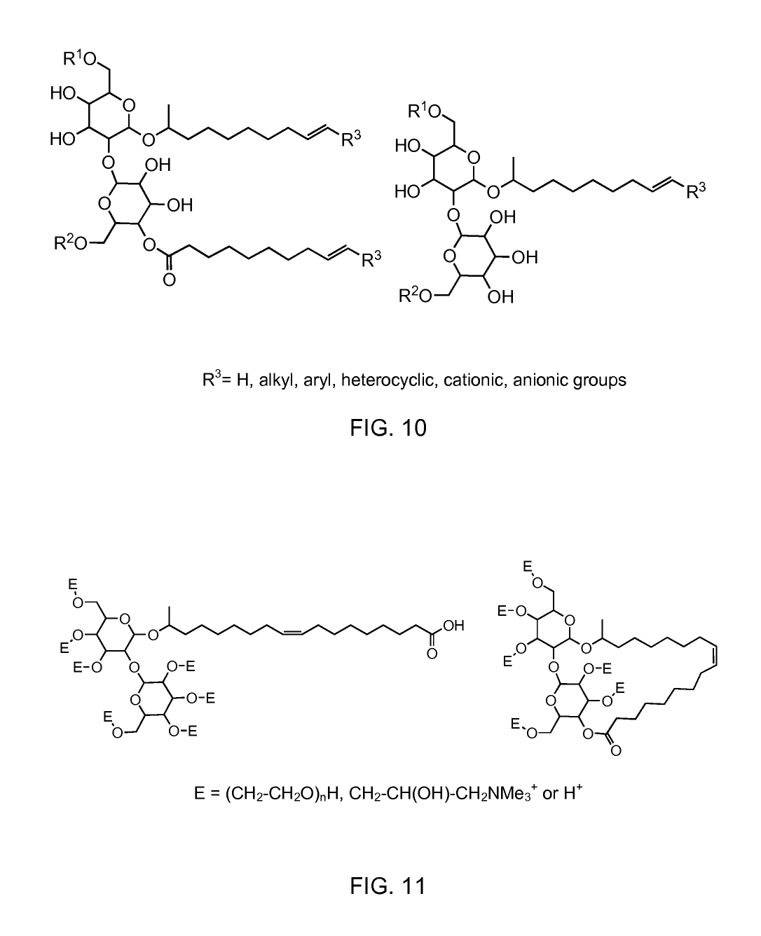

One class of MSL derivatives includes lactonic and acidic sophorolipids in which the C═C bond has been reduced by hydrogen in the presence of a catalyst (FIG. 10). An exemplary reaction, applied to the conversion of lactonic sophorolipid (2) to hydrogenated lactonic sophorolipid (5), is shown below. It is contemplated that all of the derivatives (ester, amide, acetylated sophorose, inter alia) could be synthesized in a hydrogenated form. A related class of modifications at the C═C double bond include dihydroxylation carried out, for example, using the Sharpless asymmetric dihydroxylation catalyst. Other routes familiar to one skilled in the art would include acid catalyzed hydrolysis of the corresponding epoxide that could be generated using m-chloroperbenzoic acid or the Jacobsen epoxidation catalysts. A related class of modifications at the C═C double bond include the thiol-ene reaction that would lead to the formation of the corresponding thioether.

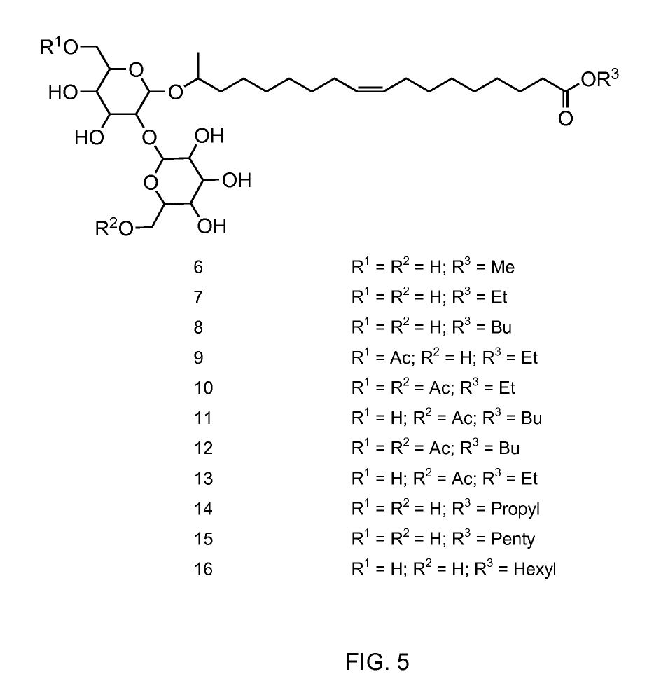

A second class of MSLs includes esterified ring-opened sophorolipids. Esterification of sophorolipids is achieved by alcoholysis of natural sophorolipid mixtures. Esters of varying chain lengths and with varying degrees of branching and containing a variety of heteroatoms are included in this invention (FIG. 5). Moreover, methods are already disclosed in the literature that describe selective acetylation of SLs at the 6′- and/or 6″-hydroxy sophorose groups. Therefore one skilled in the art will recognize that many variants may be generated by permutations of the ester functional group and sophorose acetyl groups.

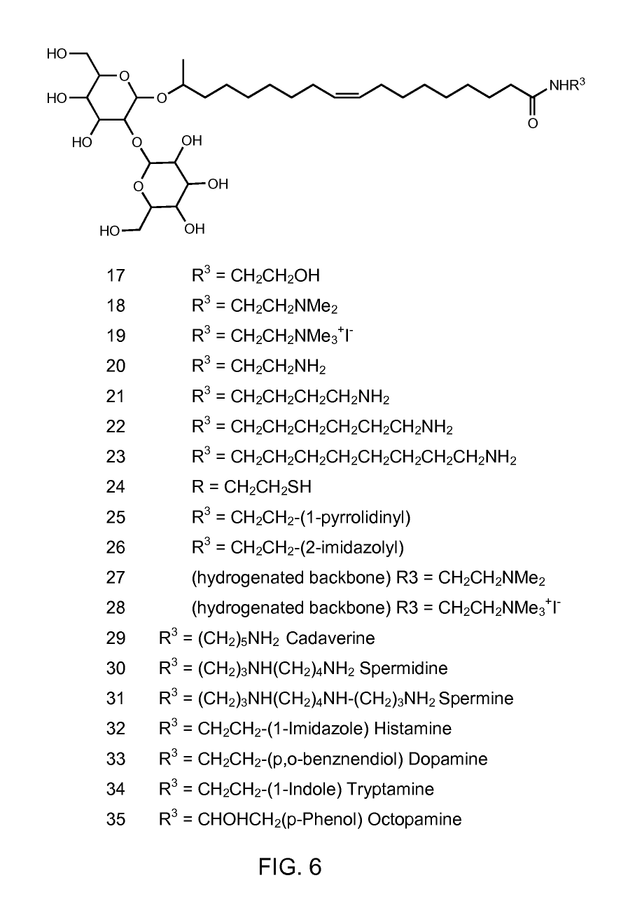

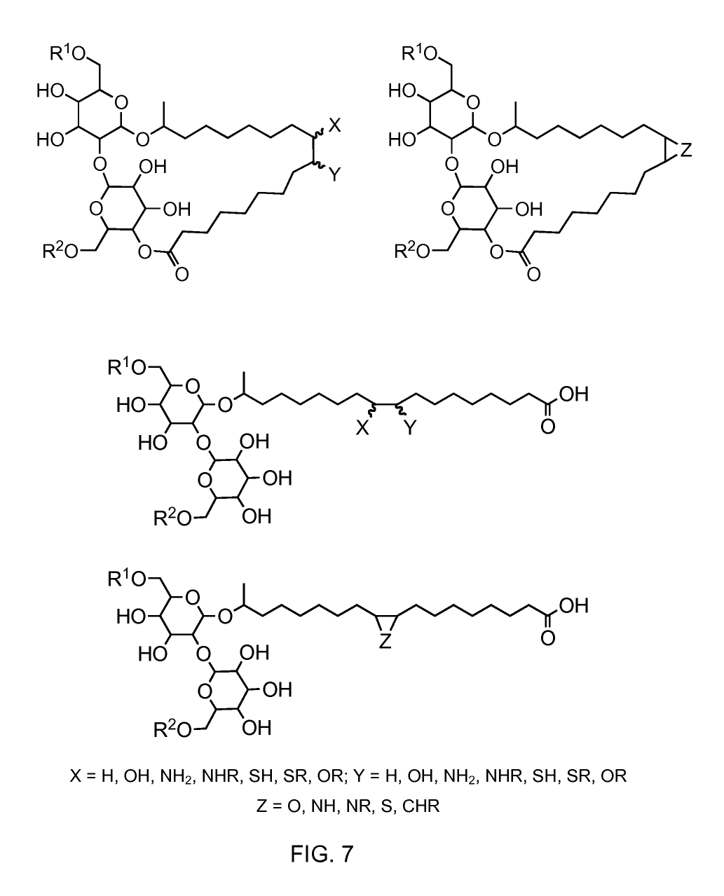

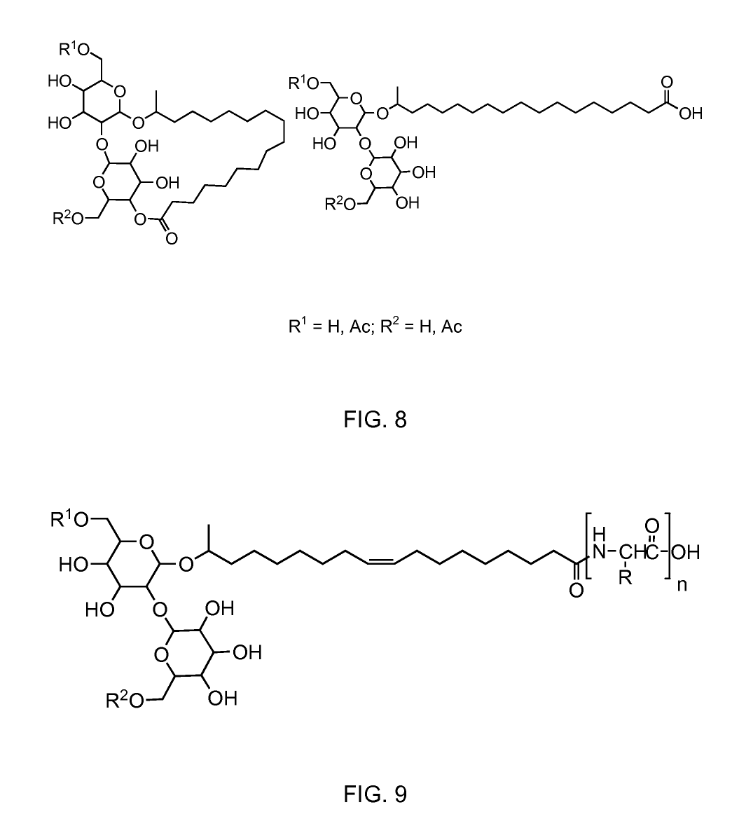

A third class of sophorolipid derivatives includes amides of acidic sophorolipids. Representative examples of sophorolipid amide derivatives are shown in FIG. 6. In the exemplary reaction shown, sophorolipid amides can be synthesized from the sophorolipid methyl ester derivative 6 by treatment with an amine at elevated temperature. It is contemplated that a variety of amines, diamines, triamines of differing chain lengths containing aliphatic, olefinic, acetylenic, and aromatic substituents can be used to synthesize the corresponding amide derivatives. Additionally, inclusive of this invention are amides derived from biogenic amines including, but not limited to, 4-aminosalicylic acid, 5-aminosalicylic acid, octopamine, 3-hydroxytyramine, phenethylamine, tryptamine, histamine, spermine, spermidine, 1,5-diaminopentane. Additionally, inclusive of this invention are amides bearing at the sophorose head group ionic moieties such as sulfate, sulfonate, phosphate, carboxylate and quarternary ammonium salts that result in cationic or anionic charged head groups. Additionally, it is contemplated that a variety of substituted amino-containing compounds can be used as a platform to expand the family of sophorolipid amides and that amino acids and polypeptides of varying chain lengths and composition can be incorporated (FIG. 9).

A fourth class of MSL includes ammonium salts derived from SL-amides with N′,N′-dimethylamino moieties. An exemplary reaction is conversion of the sophorolipid N′,N′-dimethylethylamide derivative into the corresponding ammonium salt by treatment with methyl iodide at elevated temperature. It is contemplated that the quaternary ammonium salt may be prepared from alkyl halides of varying chain length as well as β,β,β-diiodoalkanes, leading to the formation of a wide array of sophorolipid structures.

A fifth class of MSLs include those modified at the sophorose 6′ or 6″ positions by, inter alia, an activated acyl molecule such as the vinyl ester or alkyl ester of propionic acid catalyzed by an enzyme catalyst such as a lipase in conjunction with one or more of the modifications described herein. In one exemplary reaction (Bisht et al., 1999), the unsubstituted open-chain acidic sophorolipid is acetylated at the sophorose 6′-hydroxyl position. It is contemplated that carbonyl compounds of varying chain lengths and degrees of branching can be incorporated and that a variety of carbonyl-containing functional groups can be incorporated including succinate, malate and citrate. Additionally, it is contemplated that esters of amino acids and oligopeptides can be incorporated at the 6′ and/or 6″ positions of the sophorose ring. Finally, it is contemplated that the 6′ and/or 6″ positions of the sophorose ring may be alkylated (FIG. 11) by ethylene oxide or a substituted alkylene oxide such as 2,3-epoxypropyl-1,1,1-trimethylammonium chloride (Quab151) or related electrophiles as described by Solarek (1989). Such substitutions will likely occur at the primary (1°) 6′ and/or 6″ positions but may also occur at the secondary (2°) sophorose ring hydroxyl groups to generate mixtures of sophorolipid derivatives.

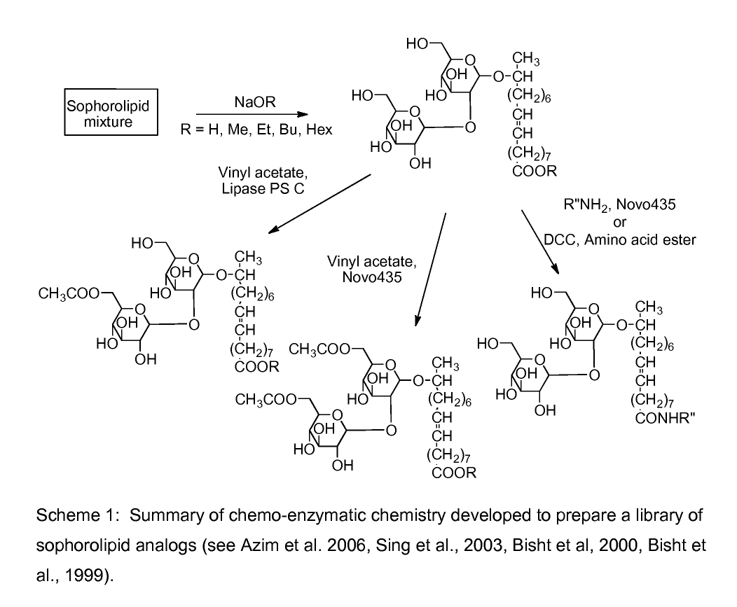

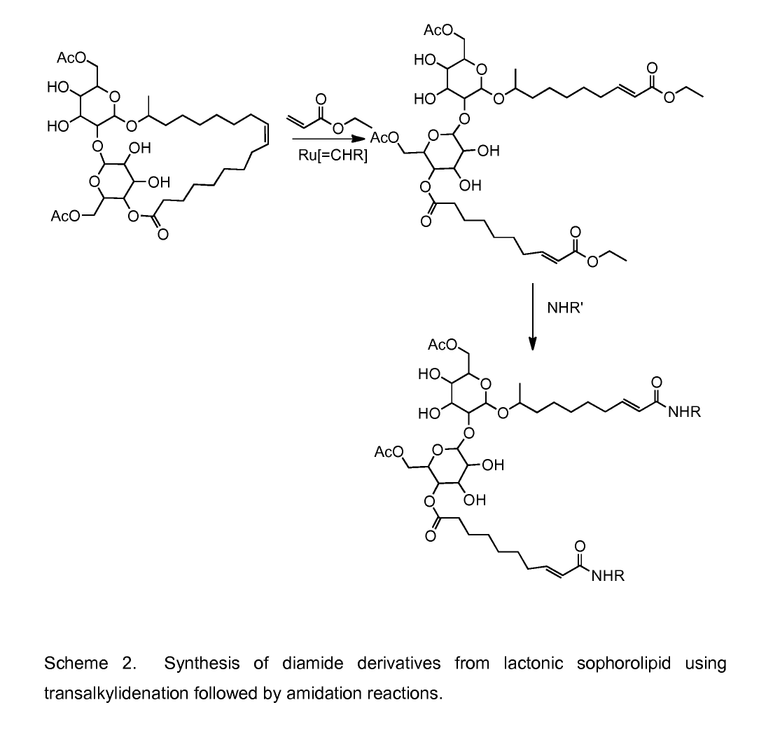

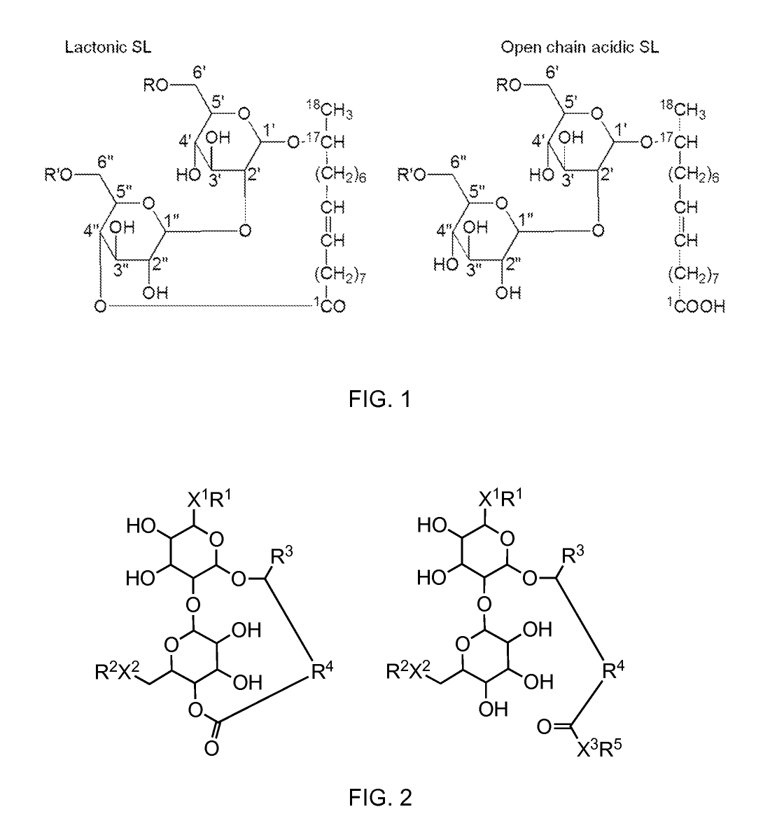

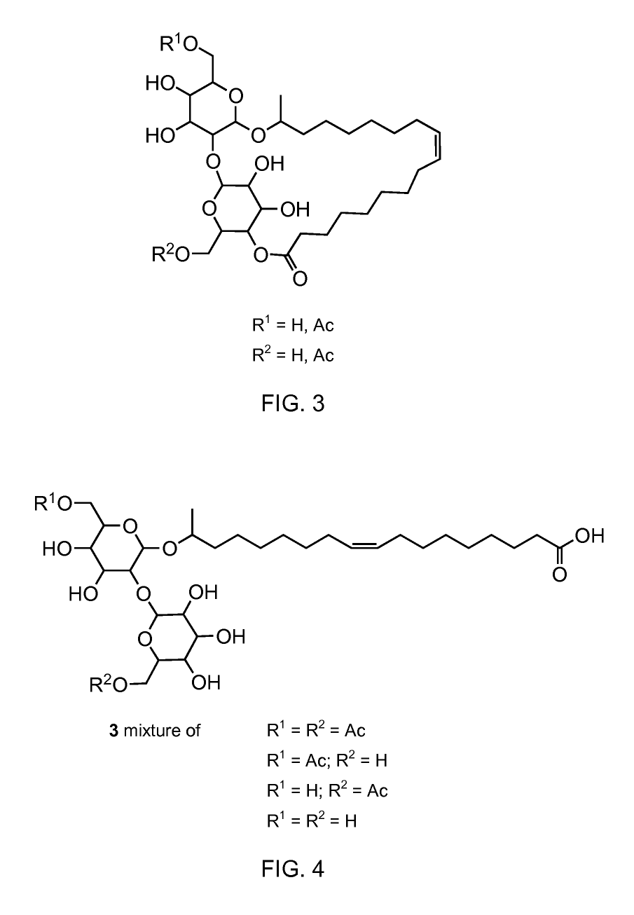

A sixth class of MSLs include those formed from transalkylidenation of carbon-carbon double bonds (C═C) within R⁴ (FIG. 2) of lactonic or open-chain acidic sophorolipids (FIG. 1). Novel compounds in this class include alkenes with linear or branched alkyl substituents. Additional novel compounds contemplated in this class are those in which the olefinic carbon generated from a transalkylidenation of carbon-carbon double bonds (C═C) within R⁴ is substituted with groups that contain an aryl, heterocyclic, cationic, anionic or neutral moieties (FIG. 10, R³═H, alkyl, aryl, alkanamide, heterocycle). The transalkylidenation chemistries described herein can be applied to carbon-carbon double bonds (C═C) within R⁴ for both the open chain and lactonic SL forms (see FIG. 2). Furthermore, combinations of metathesis (performed on either the lactonic or open chain SL) and chemical modification can be anticipated. As one illustrative example, the cross metathesis of lactonic sophorolipid with vinyl acrylate will produce a diester wherein each of the ester groups can be converted into the corresponding amide derivative (Scheme 2).

TABLE 2
Sophorolipid derivatives and sophorolipid components of the natural mixture used in bacterial and
fungal plant pathogen assays. The hydroxylated fatty acid of the natural mixture is predominantly 17-hydroxyoleic acid. However,
other fatty acid constituents with variations in chain length and unsaturation may also be present.

| Class/Structure | Substituent(s) | Code |
|---|---|---|
| Natural Sophorolipids | Mixture of 2 and 3 | 1 |
| 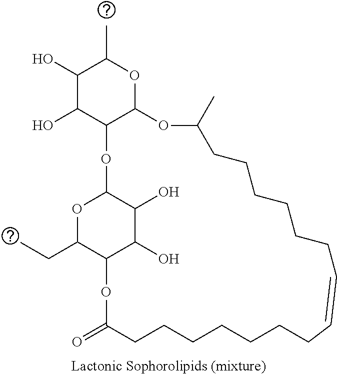 [SMILES: CCC1OC2OC3C(OC(C)CCCCCC/C=C\CCCCCCCC(=O)OC1C(O)C2O)OC(C)C(O)C3O] | R¹ = R² = OAc R¹ = H; R² = OAc R¹ = OAc; R² = H R¹ = R² = H | 2 |
| 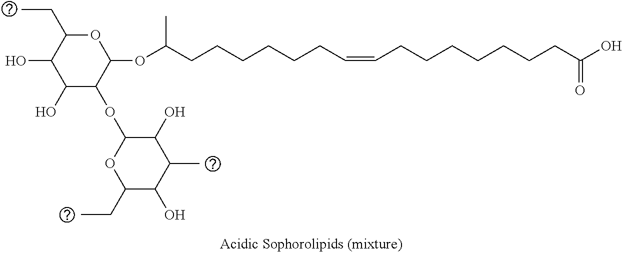 [SMILES: CCC1OC(OC2C(OC(C)CCCCCC/C=C\CCCCCCCC(=O)O)OC(CC)C(O)C2O)C(O)C(C)C1O] | R¹ = R² = OAc R¹ = H; R² = OAc R¹ = OAc; R² = H R¹ = R² = H | 3 |
| Hydrogenated natural sophorolipids | Mixture | 4 |
| Hydrogenated lactonic sophorolipids | R¹ = R² = Ac | 5 |
| 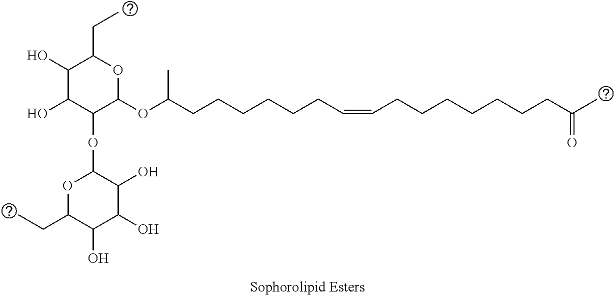 [SMILES: CCC1OC(OC2C(OC(C)CCCCCC/C=C\CCCCCCCC(C)=O)OC(CC)C(O)C2O)C(O)C(O)C1O] | R¹ = R² = H; R³ = Me R¹ = R² = H; R³ = Et R¹ = R² = H; R³ = Bu R¹ = Ac; R² = H; R³ = Et R¹ = R² = Ac; R³ = Et R¹ = H; R² = Ac; R³ = Bu R¹ = R² = Ac; R³ = Bu R¹ = H; R² = Ac; R³ = Et R¹ = R² = H; R³ = propyl R¹ = R² = H; R³ = pentyl R¹ = R² = H; R³ = Hexyl | 6 7 8 9 10 11 12 13 14 15 16 |
| 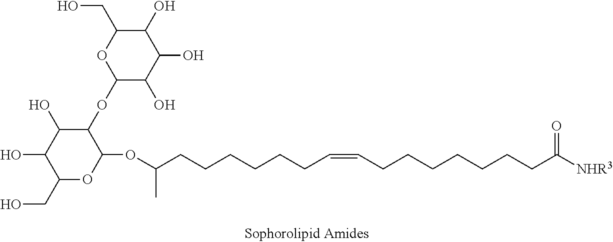 | R³ = CH₂CH₂OH R³ = CH₂CH₂NMe₂ R³ = CH₂CH₂NMe₃⁺ R³ = CH₂CH₂NH₂ R³ = (CH₂)₄NH₂ R³ = (CH₂)₆NH₂ R³ = (CH₂)₈NH₂ R³ = CH₂CH₂SH R³ = CH₂CH₂-(1-pyrrolidinyl) R³ = CH₂CH₂-(2-imidazolyl) | 17 18 19 20 21 22 23 24 25 26 |
| 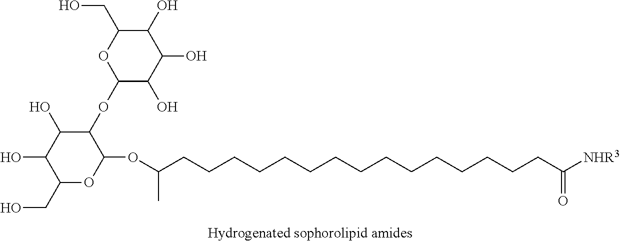 | R³ = CH₂CH₂NMe₂ R³ = CH₂CH₂NMe₃⁺ | 27 28 |
| 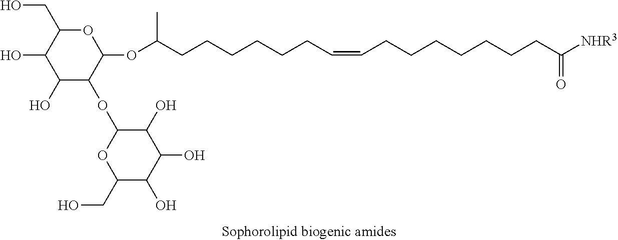 | R³ = (CH₂)₅NH₂ R³ = (CH₂)₃NH(CH₂)₄NH₂ R³ = (CH₂)₃NH(CH₂)₄NH—(CH₂)₃NH₂ R³ = CH₂CH₂-(1-Imidazole) R³ = CH₂CH₂-(p,o-benznendiol) R³ = CH₂CH₂-(1-Indole) R³ = CHOHCH₂(p-Phenol) | 29 30 31 32 33 34 35 |

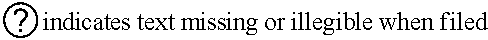

Representative Examples of Antibacterial and Antifungal Activity Natural SLs and MSLs

### EXAMPLE 1

### Antifungal Activity of MSL Combinations Against Plant Fungal Pathogens

Antifungal activity of MSL combinations were confirmed by experiment and observations. The compounds used in antifungal assays are 1, 2, 6, 7, and 8. In this assay, MSLs and natural SLs (single component or mixture) were tested individually (i.e., only one MSL) and in combinations (i.e., MSL+MSL or MSL+natural SL) against a panel of 18 different fungi. In all cases mixtures consisted of equal quantities of each component of the mixture (i.e., 1:1 ratio of MSL-X+MSL-Y, w/w). The natural SL (single component or mixture) and MSL samples were dissolved in 5% (w/v) Tween 20 and 5% (w/v) Propylene glycol solution to a final concentration of 10 mg/mL (i.e., 5 mg of MSL-X and 5 mg of MSL-Y) that was used as a stock solution. The stock solution (100 μL) was added into a 96 well microplate and serially diluted from 10 mg/mL to 0.0024 mg/mL using culture medium. The culture media used for antifungal assay include, mineral salts medium (for Botrytis cinerea), corn meal broth (for Phytopthora infestans and P. capsici) and potato dextrose broth for all other fungi. After serial dilution, 80 μL of fresh culture medium and 20 μL of fungal spore suspension were added to each well and the plates were incubated for 7 days at 25 to 28° C. The minimum (growth) inhibitory concentration (MIC) was determined to measure antifungal activity of MSL compounds. MIC values for antifungal activity were determined by the absence of visible growth in the micro wells containing MSL after 7 days of incubation. Anti-fungal assay results shown in Table 3 revealed that combinations of MSL+MSL or MSL+natural SL (component or mixture) increased the antifungal activity of the MSL combination by 4 to 1000 times that compared to their activity when tested individually.

TABLE 3
Antifungal activity of natural and MSL combinations using equal quantities
of each component in the mixture (i.e., 1:1 ratio of MSL-X + MSL-Y, w/w)

| | Compound codes | | | | | | | | |
|---|---|---|---|---|---|---|---|---|---|
| | 7 + 8 | 1 + 8 | 1 + 7 | 2 + 8 | 2 + 7 | 8 | 7 | 2 | 1 |
| Pathogen | MIC in mg/mL | | | | | | | | |
| Alternaria tomatophilia | 0.009 | 0.009 | 2.5 | 0.009 | 0.009 | 1.25 | 5 | 10 | 2.5 |
| A. solani | 0.156 | 0.156 | 1.25 | 0.009 | 0.01 | 0.6 | 2.5 | 10 | 2.5 |
| A. alternata | — | — | 10 | 5 | — | 10 | 10 | 1.25 | 2.5 |
| Fusarium oxysporum | 2.5 | 0.009 | 0.15 | 10 | 0.07 | 5 | 10 | 10 | — |
| Botrytis cinerea | 0.009 | 0.009 | 10 | 5 | 2.5 | 10 | 1.25 | 10 | — |
| Phytophthora capsici | — | — | — | — | — | — | — | — | — |
| Ustilago maydis | — | — | — | — | — | 1.25 | 2.5 | 10 | — |
| Phytophthora Infestans | — | — | — | — | — | — | — | — | — |
| Fusarium asiaticum | 2.5 | 0.31 | 1.25 | 1.25 | 2.5 | 5 | 2.5 | 10 | — |
| F. austroamericana | 1.25 | 0.62 | 2.5 | 0.156 | 0.31 | 0.6 | 5 | 1.25 | — |
| F. cerealis | 2.5 | — | 5 | 1.25 | 10 | — | 10 | — | — |
| F. graminearum | 1.25 | 0.15 | 10 | 0.01 | 0.009 | 5 | 10 | 10 | — |
| Penicillium chrysogenum | 0.31 | 0.62 | — | 0.62 | 0.31 | 10 | 10 | 1.25 | 1.25 |
| P. digitatum | 0.019 | 0.019 | 5 | 0.009 | 0.03 | 1.25 | 5 | 1.25 | 0.6 |
| P. funiculosum | 10 | 10 | — | 10 | — | 10 | 10 | — | — |
| Aspergillus niger | — | — | — | — | — | — | — | — | — |
| Aureobasidium pullulans | 0.62 | 1.25 | 1.25 | 0.03 | 1.25 | 10 | — | 2.5 | — |
| Chaetomium globosum | 0.009 | — | — | 0.01 | 5 | 2.5 | 5 | 5 | |

MIC = Minimum Inhibitory Concentration in mg/mL
Compound names
1 Natural sophorolipid mixture
2 Lactonic sophorolipid
6 SL-Methylester
7 SL-Ethylester
8 SL-Butylester

### Example 2

### Antibacterial Activity of MSL Combinations Against Plant Bacterial Pathogens

Bacterial infections in plants are much like the symptoms in fungal plant diseases. Examples are leaf spots, blights, wilts, scabs, cankers and soft rots of roots, storage organs and fruit, and overgrowth. To determine the antibacterial activity of SL-derivatives, 7 different plant pathogenic bacteria were used (Table 4). The compounds used in antibacterial assay are 1, 2, 6, 7, 8, 16. In this assay, MSLs were tested individually (i.e., only one MSL) and in combinations (i.e., MSL+MSL or MSL+natural SL) against a panel of 7 different bacteria. In all cases mixtures consisted of equal quantities of each component of the mixture (i.e.,1:1 ratio of MSL-X+MSL-Y, w/w). Combinations were dissolved in 5% (w/v) Tween 20 and 5% (w/v) propylene glycol solution to a final concentration of 10 mg/mL that was used as a stock solution. The stock solution (100 μL) was added into a 96 well microplate and serially diluted from 10 mg/mL to 0.0024 mg/mL using culture medium. The culture media used for antibacterial assay is Tryptic Soy Broth. After serial dilution, 95 μL of fresh culture medium and 5 μL of bacterial cell suspension were added to each well and the plates were incubated for 24 to 48 h at 30° C. Antibacterial activity was determined by measuring the optical density (OD) of micro wells containing MSL and bacterial culture at 540 nm in a spectrophotometer. A control was maintained for each bacterial culture without adding MSL into the culture medium. The difference in OD between MSL added wells and the control was calculated and converted into %-growth inhibition. The formula used for the calculation of %-growth inhibition is: [Control OD−OD of MSL added wells/Control OD]×100. As noted in antifungal assays, the combination of MSL with MSL or MSL with natural SL (component or mixture) leads to increased antibacterial activity by 10 to 50% when compared to the antibacterial activity observed for each compound without using the combination invention. The results are shown in Table 4 and Table 5.

TABLE 4
Activity against plant bacterial pathogens of natural and MSL
combinations using equal quantities of each component in the mixture (i.e., 1:1
ratio of MSL-X + MSL-Y, w/w)

| | Compound codes | | | | | | | | |
|---|---|---|---|---|---|---|---|---|---|
| | 8 + 2 | 8 + 1 | 7 + 2 | 7 + 1 | 8 + 7 | 8 | 7 | 2 | 1 |
| Plant bacterial | %-growth inhibition | | | | | | | | |
| Pathogens | MIC 10 mg/mL | | | | | | | | |
| Pseudomonas | 100 | 85 ± 8 | 100 | 66 ± 8 | 100 | 80 ± 2 | 70 | 59 ± 6 | — |
| syringae | | | | | | | | | |
| Xanthomonas | 100 | 93 ± 2 | 100 | 85 ± 4 | 100 | 79 ± 5 | 76 ± 5 | 57 ± 5 | 37 ± 03 |
| campestris | | | | | | | | | |
| Pectobacterium | 100 | 100 | 100 | 84 ± 6 | 100 | 82 ± 8 | 68 ± 3 | 62 ± 4 | 45 ± 04 |
| carotovorum | | | | | | | | | |
| Acidovorax | 100 | 87 ± 4 | 100 | 80 ± 5 | 100 | 84 | 79 ± 8 | 62 ± 2 | 29 ± 06 |
| Carotovorum | | | | | | | | | |
| Ralstonia | 100 | 100 | 100 | 92 | 100 | 88 ± 7 | 85 ± 7 | 63 ± 3 | 22 ± 04 |
| solanacearum | | | | | | | | | |
| Erwinia amylovora | 100 | 100 | 100 | 90 | 100 | 82 ± 4 | 80 ± 6 | 62 ± 7 | 25 ± 05 |
| Pseudomonas | 100 | 100 | 100 | 100 | 100 | 83 ± 9 | 81 | 65 ± 4 | — |
| cichorii | | | | | | | | | |

MIC = Minimum Inhibitory Concentration in mg/mL
Compound names
1 Natural sophorolipid
2 Lactonic sophorolipid
6 SL-Methylester
7 SL-Ethylester
8 SL-Butylester

TABLE 5
Activity against plant bacterial pathogens of natural and MSL
combinations using equal quantities of each component in the mixture (i.e., 1:1
ratio of MSL-X + MSL-Y, w/w)

| | Compound codes | | | | | | | | |
|---|---|---|---|---|---|---|---|---|---|
| | 8 + 16 | 7 + 16 | 2 + 16 | 1 + 16 | 8 | 7 | 16 | 2 | 1 |
| Plant bacterial | %-growth inhibition | | | | | | | | |
| pathogens | MIC 10 mg/mL | | | | | | | | |
| Pseudomonas | 100 | 100 | 100 | 57 ± 6 | 80 ± 2 | 70 | 82 ± 2 | 59 ± 6 | — |
| syringae | | | | | | | | | |
| Xanthomonas | 100 | 100 | 100 | 73 ± 8 | 79 ± 5 | 76 ± 5 | 60 ± 4 | 57 ± 5 | 37 ± 03 |
| campestris | | | | | | | | | |
| Pectobacterium | 100 | 100 | 100 | 74 ± 5 | 82 ± 8 | 68 ± 3 | 81 ± 3 | 62 ± 4 | 45 ± 04 |
| carotovorum | | | | | | | | | |
| Acidovorax | 100 | 100 | 100 | 81 ± 8 | 84 | 79 ± 8 | 63 ± 4 | 62 ± 2 | 29 ± 06 |
| Carotovorum | | | | | | | | | |
| Ralstonia | 100 | 100 | 100 | 85 ± 7 | 88 ± 7 | 85 ± 7 | 93 | 63 ± 3 | 22 ± 04 |
| solanacearum | | | | | | | | | |
| Erwinia | 100 | 100 | 100 | 81 ± 9 | 82 ± 4 | 80 ± 6 | 43 ± 2 | 62 ± 7 | 25 ± 05 |
| amylovora | | | | | | | | | |
| Pseudomonas | 100 | 100 | 100 | 90 ± 7 | 83 ± 9 | 81 | 21 | 65 ± 4 | — |
| cichorii | | | | | | | | | |

MIC = Minimum Inhibitory Concentration in mg/mL
Compound names
1 Natural sophorolipid
2 Lactonic sophorolipid
6 SL-Methylester
7 SL-Ethylester
8 SL-Butylester
16 SL-Hexylester

### Example 3

### Antibacterial Activity of MSL Combinations Against Biofilm Forming Bacterial Strains

Similar to plant bacterial and fungal pathogens, microbial (e.g., mold) fouling on painted walls in house, office and storage facilities causes frequent maintenance and unpleasant odor. Marine fouling is a big problem in shipping industry and marine structures such as cooling towers. Biofouling causes significant damage to ships and cooling towers in terms of maintenance time and repair costs. To determine the antibacterial activity of natural or MSLs, 8 different biofilm forming bacteria were used (Table 6). The compounds used in the antibacterial assay are 1, 2, 6, 7, 8 and 16. In this assay, MSLs and natural SLs were tested individually (i.e., only one MSL) against a panel of 8 different biofilm bacteria. MSL samples were dissolved in 5% (w/v) Tween 20 and 5% (w/v) Propylene glycol solution to a final concentration of 10 mg/mL that was used as a stock solution. The stock solution (100 μL) was added into a 96 well microplate and serially diluted from 10 mg/mL to 0.0024 mg/mL using culture medium. The culture media used for antibacterial assay is Tryptic Soy Broth. After serial dilution, 95 μL of fresh culture medium and 5 μL of bacterial cell suspension were added to each well and the plates were incubated for 24 to 48 h at 30° C. Antibacterial activity was determined by measuring the optical density (OD) of micro wells containing MSL and bacterial culture at 540 nm in a spectrophotometer. A control was maintained for each bacterial culture without adding MSL into the culture medium. The difference in OD between MSL added wells and the control was calculated and converted into %-growth inhibition. The formula used for the calculation of %-growth inhibition is: [Control OD−OD of MSL added wells/Control OD]×100. The MSLs and natural SL tested in this assay showed 55 to 98% growth inhibition activity against the 8 bacterial strains tested. The results are shown in Table 6.

TABLE 6
Antimicrobial activity of natural SLs and
MSLs against biofouling bacterial strains

| | Compound codes | | | |
|---|---|---|---|---|
| | 8 | 7 | 16 | 2 |
| | %-growth inhibition | | | |
| Plant bacterial pathogens | MIC 2.5 to 10 mg/mL | | | |
| Alcaligenes faecalis | 81 | 79 ± 9 | 79 | 78 ± 7 |
| Pseudomonas oleovorans/ | 92 ± 5 | 95 ± 2 | 95 | 94 ± 6 |
| pseudoalcaligenes | | | | |
| Pseudomonas alcaliphila | 97 ± 7 | 94 ± 8 | 98 ± 2 | 96 ± 8 |
| Pseudomonas alcaliphila | 86 ± 8 | 90 | 87 ± 8 | 90 ± 4 |
| Pseudomonas aeruginosa | 55 ± 7 | 59 ± 4 | 73 ± 4 | 34 |
| Pseudomonas aeruginosa | 64 ± 2 | 68 ± 8 | 62 ± 6 | 74 ± 9 |
| Stenotrophomonas maltophila | 65 ± 3 | 67 ± 3 | 83 ± 8 | 65 |
| Microbacterium paraoxydans | 76 | 81 ± 8 | 84 ± 7 | 88 ± 4 |

MIC = Minimum Inhibitory Concentration in mg/mL
Compound names
2 Lactonic sophorolipid
6 SL-Methylester
7 SL-Ethylester
8 SL-Butylester
16 SL-Hexylester

This invention demonstrates that by: i) mixing two MSLs or mixing more than two MSLs; ii) mixing one MSL or more than one MSL with a SL component of the natural mixture; or iii) mixing one MSL or more than one MSL with one or more SL components of the natural mixture, such mixtures result in synergistic effects whereby the combination of compounds results in much higher activity then the additive contributions of each of the components alone to kill or inhibit the growth of pathogens such as pathogens of plants, animals and humans as well as normal bacteria that grow on surfaces (e.g. bio-fouling microbes). Microbes that can be killed or inhibited by the combination invention include but are not limited to algae, fungi, bacteria, virus and protozoa. This invention demonstrates that by: i) mixing two MSLs or mixing more than two MSLs; ii) mixing one MSL or more than one MSL with a SL component of the natural mixture; or iii) mixing one MSL or more than one MSL with one or more SL components of the natural mixture, such mixtures result in synergistic effects whereby the combination of compounds results in much higher activity of the additive contributions of each of the components alone to kill or inhibit the growth of pathogens such as pathogens of plants, animals and humans as well as normal bacteria grow on surfaces (e.g. bio-fouling microbes). Microbes that can be killed or inhibited by the combination invention include but are not limited to algae, fungi, bacteria, virus and protozoa.

This invention demonstrates that by: i) mixing two MSLs or mixing more than two MSLs; ii) mixing one MSL or more than one MSL with a SL component of the natural mixture; or iii) mixing one MSL or more than one MSL with one or more SL components of the natural mixture, such mixtures result in synergistic effects whereby the combination of compounds results in much higher antimicrobial activity then the additive contributions of each of the components alone. MSLs incorporated in this invention also include those that result by performing multiple modification chemistries on a natural sophorolipid precursor. A small subset of the large number of permutations that result from performing multiple modifications on a natural SL precursor are given in the following examples: i) hydrogenation of the fatty acid carbon-carbon double bond and esterification of the fatty acid carboxyl group; ii) hydrogenation of the carbon-carbon double bond and amidation at the carboxylate group; and iii) transalkylidination of the SL-lipid carbon-carbon double bond by reaction with methyl acrylate followed by amidation at the formed methyl ester moiety, vi) amidation at the carboxylate and acetylation at the sophorose head group.

As a single example, one skilled in the art of organic synthesis can use combinations of synthetic techniques described herein to synthesize ring-opened sophorolipid amide derivatives in which the C═C double bond remains intact or is hydrogenated. But, the novel surprising results reported in this invention are the enhanced antimicrobial activity that results by i) mixing two MSLs or mixing more than two MSLs, ii) mixing one MSL or more than one MSL with a SL component of the natural mixture, iii) mixing one MSL or more than one MSL with one or more SL components of the natural mixture. Such mixtures result in synergistic effects whereby the combination of compounds results in much higher activity then the additive contributions of each of the components alone to kill or inhibit the growth of pathogens such as pathogens of plants, animals and humans as well as normal bacteria that grow on surfaces (e.g. bio-fouling microbes). Results of up to 1000 fold increase in activity by using the combination invention could not have been anticipated by one skilled in the art and represents the innovative step of this invention.

Thus, the invention is a method for controlling microbes; inhibition of their growth and killing of live cells and spores, comprising: providing an admixture of compounds that consist of two or more constituents that include a natural sophorolipid component, natural sophorolipid mixture or a modified sophorolipid, and applying said admixture to a plant, surface, device, or any system containing microbes that have grown or might grow which are undesirable. Representative and preferred components and features of the invention are provided below.

The various microbes to which the invention can be applied include known or not yet discovered plant pathogens; human pathogens; live cells or spores in the group that consists of: bacteria, fungi, viruses, algae and protozoan; microbes or combination of microbes that grow on surfaces causing fouling or contamination of that surface; and instances where a microbe has accumulated in access due to some shift in the ecosystem such as accumulation of a non-natural chemical in lakes.

Other microbes to which the invention can be applied include those that form biofilms that contaminate surfaces such as, but not limited to catheters, medical dives, walls, shower curtains, swimming pools, pipelines, water filters, cooling towers, marine structures, ships, boats, navigational aids, channel markers, buoys, and oil exploration plat forms.

Representative MSL derivatives can be synthesized by methods that are known from the prior art using natural sophorolipids produced by fermentation from a feedstock mixture, wherein the fatty acid is selected from the group consisting of tallow, sunflower oil, rapeseed oil, safflower oil, soya bean oil, palm oil, coconut oil, olive oil, and short-chain to medium chain length carboxylic acid having an alkyl chain length from 6 to 22 carbons.

The MSL derivatives can be obtained without purifying the reaction mixture or pure compounds of the same. The MSL derivatives can be obtained from sophorolipid mixtures of different purity with varying contents of natural to open chain sophorolipids.

The admixture can consist of 2 MSL compounds of different compositions. The admixture can consist of mixing 2 or more MSL compounds of different compositions. The admixture can consist of mixing 1 MSL and 1 or more natural sophorolipid components. The admixture can consist of mixing 1 MSL and a natural SL mixture. The admixture can consist of mixing one or more MSLs and one or more natural sophorolipid components.

The admixture can be applied as a solution that can be a concentrate or at an appropriate concentration for use. The admixture can be in powder form and applied as a powder or dissolved in a solution prior to application.

The compound mixture of the present invention acts synergistically to increase the antimicrobial activity relative to any of the components in the mixture tested alone. For example, the admixture acts synergistically in a ratio where the component with the lowest concentration is 1:200^{th} (w/w) of the summation of the other components and the component of the admixture that is in the highest concentration is up to 30 times greater than the summation of the other components.

The admixture can further include chemical or biobased emulsifiers, biosurfactants, surfactants, and eco-friendly organic solvents used in pesticides, antimicrobial agent(s), disinfectant(s), personnel hygienic agents and cosmetics.

The admixture further include inert components used in the formulation of pesticides, biopesticides, biochemical pesticides and antimicrobial agents, disinfectants, personnel hygienic agents and cosmetics such as adjuvants, buffering agents or pH adjusting agents/salts and solublizers.

The physical form of formulated mixtures can be as a wettable powder, powders, dust, granules, liquids, gels, semisolids, colloidal materials, paste, incorporated in wipes, papers, polymers and in any other form a potential pesticide, biopesticide, biochemical pesticide, antimicrobial agent, disinfectant, personnel hygienic agent and cosmetics can be formulated.

Inert components suitable for use as an adjuvant or that may possess pesticide, antimicrobial, disinfectant, personnel hygienic activities, include those of natural origin that complement the natural aspects of the natural SL, MSL derivative and MSL combinations and can be either an oil component such as cinnamon oil, clove oil, cottonseed oil, garlic oil, or rosemary oil; another natural biosurfactant or synthetic surfactant; or the component may be an aldehyde such as cinnamic aldehyde, ands wherein other oils that may be used as a pesticidal and antimicrobial component or adjuvants include: almond oil, camphor oil, castor oil, cedar oil, citronella oil, citrus oil, coconut oil, corn oil, eucalyptus oil, fish oil, geranium oil, lecithin, lemon grass oil, linseed oil, mineral oil, mint or peppermint oil, olive oil, pine oil, rapeseed oil, safflower oil, sage oils, sesame seed oil, sweet orange oil, thyme oil, vegetable oil, and wintergreen oil, and wherein other suitable additives are all substances, which are customarily used for such preparations, examples of which include adjuvants, surfactants, emulsifying agents, plant nutrients, fillers, plasticizers, lubricants, glidants, colorants, pigments, bittering agents, buffering agents, solubility controlling agents, pH adjusting agents, preservatives, stabilizers and ultra-violet light resistant agents, and wherein stiffening or hardening agents may also be incorporated to strengthen the formulations and make them strong enough to resist pressure or force in certain applications such as soil, root flare or tree injection tablets.

Suitable buffering agents include organic and amino acids or their salts, wherein suitable buffers include citrate, gluconate, tartrate, malate, acetate, lactate, oxalate, aspartate, malonate, glucoheptonate, pyruvate, galactarate, glucarate, tartronate, glutamate, glycine, lysine, glutamine, methionine, cysteine, arginine and a mixture thereof, phosphoric and phosphorous acids or their salts, and wherein synthetic buffers are suitable to be used but it is preferable to use natural buffers such as organic and amino acids or their salts listed above.

Solubility control agents or excipients also can be used in the inventive formulations to control the release of the active substances, examples of which include wax, chitin, chitosan, C12-C20 fatty acids such as myristic acid, stearic acid, palmitic acid; C12-C20 alcohols such as lauryl alcohol, cetyl alcohol, myristyl alcohol, and stearyl alcohol; amphiphilic esters of fatty acids with glycerol, especially monoesters C12-C20 fatty acids such as glyceryl monolaurate, glyceryl monopalmitate; glycol esters of fatty acids such as polyethylene glycol monostearate or polypropylenemonopalmitate glycols; C12-C20 amines such lauryl amine, myristyl amine, stearyl amine, and amides of C12-C20 fatty acids.

Suitable pH adjusting agents include potassium hydroxide, ammonium hydroxide, potassium carbonate or bicarbonate, hydrochloric acid, nitric acid, sulfuric acid or a mixture thereof.

Additional components also can be included in aqueous preparation formulations of the inventive compositions, such as the salt form of polyprotic acids, examples of which include sodium bicarbonate, sodium carbonate, sodium sulfate, sodium phosphate, sodium biphosphate.

Suitable synthetic surfactant include alkyl betaines, alkyl sulfates, alkyl ammonium bromide derivatives, alkyl phenol ethoxylates, alkyl ethylene or polyethylene ethoxylates, alkyl or acyl glycosides, tween 80, tween 60, tween 40, tween 20, polypropylene glycol and biosurfactants.

Suitable biosurfactants or surface active compounds that are embodied in the combination invention can be formulated with one or more members of the consisting of other natural glycolipids that include rhamnolipids, mannosylerythritol, cellobiose lipids, trehalose lipids, emulsan, lipopeptides, surfactin, lipoproteins, lipopolysaccharide-protein complexes, phospholipids, and polysaccharide-protein-fatty acid complexes and any other compound(s) with potential uses as a biosurfactant.

The biosurfactants or surface active compounds can be pure, crude or directly collected from culture broth or the culture broth having surface active agents in it.

The natural SL, MSL derivative and combinations thereof encompassed by the combination invention can be applied by spraying, pouring, dipping, in the form of concentrated or diluted liquids, solutions, suspensions, powders, incorporated in wipes, papers and polymers and the like, containing such concentrations of the active agent as is most suited for a particular purpose and application.

The natural SL, MSL derivative and combinations thereof encompassed by the combination invention can be formulated such that they are solid formulations that can different forms and shapes such as cylinders, rods, blocks, capsules, tablets, pills, pellets, strips, and spikes, and wherein solid formulations may also be milled, granulated or powdered, and wherein the granulated or powdered material may be pressed into tablets or used to fill pre-manufactured gelatin capsules or shells, ad wherein semi solid formulations can be prepared in paste, wax, gel, or cream preparations.

The natural SL, MSL derivative and combinations thereof encompassed by the combination invention can be used for human or animal applications; the formulations may be prepared in liquid, paste, ointment, suppository, capsule or tablet forms and used in a way similar to drugs used in the medicinal drugs industry, the formulations can be encapsulated using components known in the pharmaceutical industry so as to protect the components from undesirable reactions and help the ingredients resist adverse conditions in the environment or the treated object or body e.g. stomach.

The natural SL, MSL derivative and combinations thereof encompassed by the combination invention can be applied to plants, pests, or soil using various methods of application depending on certain circumstances.

The natural SL, MSL derivative and combinations thereof encompassed by the combination invention can be introduced directly in the soil in the vicinity of plant roots, in the form of liquid, bait, powder, dusting, or granules, or alternatively, the biopesticidal compositions may be inserted in the soil as tablets, spikes, rods, or other shaped moldings.

The natural SL, MSL derivative and combinations thereof encompassed by the combination invention can be formulated and used for treating individual plant, tree, plants or trees, for example, the formulations can be molded in different shapes or forms (solid, paste or gel, or liquid) and introduced into the vascular tissue of the plants, and wherein the moldings forms can be as tablets, capsules, plugs, rods, spikes, films, strips, nails, or plates, and wherein the shaped moldings can be introduced into pre-drilled holes into the plants or root flares, or they can be pushed or punched into the cambium layer.

The natural SL, MSL derivative and combinations thereof encompassed by the combination invention after formulation can be applied by the use of dispensing devices such as syringes, pumps or caulk guns, paste-tubes or plunger tubes for delivering semi-solid formulations (paste, gel, cream) into drilled holes in tree trunks or root flares.

The natural SL, MSL derivative and combinations thereof encompassed by the combination invention after formulation can be applied in the form of paste, gel, coatings, strips, or plasters onto the surface of the plant, a plaster or strip may be in a semi-solid formulation, e.g., insecticide placed on the side that will contact the tree, bush, or rose during the treatment, and wherein the same strip may have glue or adhesive at one or both ends to wrap around or stick to the subject being treated.

The natural SL, MSL derivative and combinations thereof encompassed by the combination invention after formulation can be sprayed or dusted on the leaves in the form of pellets, spray solution, granules, or dust.

The natural SL, MSL derivative and combinations thereof encompassed by the combination invention after formulation can be solid or semi-solid compositions that can be coated using film-coating compounds used in the pharmaceutical industry such as polyethylene glycol, gelatin, sorbitol, gum, sugar or polyvinyl alcohol, which is particularly essential for tablets or capsules used in pesticide formulations, and wherein film coating can protect the handler from coming in direct contact with the active ingredient in the formulations, and where, in addition, a bittering agent such as denatonium benzoate or quassin may also be incorporated in the pesticidal formulations, the coating or both.

The concentrations of the ingredients in the formulations and application rate of the compositions may be varied widely depending on the pest, plant, animal, human, microbes or area treated, or method of application, wherein the compositions and methods of the invention can be used to control a variety of pests, microbes, including insects and other invertebrates, algae, and, in some situations, weeds or other plants.

The above detailed description of the embodiments, and the examples, are for illustrative purposes only and are not intended to limit the scope and spirit of the invention, and its equivalents, as defined by the appended claims. One skilled in the art will recognize that many variations can be made to the invention disclosed in this specification without departing from the scope and spirit of the invention.

### REFERENCES

1. Stanghellini, M. E., D. H. Kim, S. L. Rasmussen and P. A. Rorabaugh. 1996. Control of root rot of peppers caused by Phytophthora capsici with a nonionic surfactant. Plant Dis. 80:1113-1116.
2. Stanghellini, M. E., R. M. Miller. 1997. Biosurfactants: their identity and potential efficacy in the biological control of zoosporic plant pathogens. Plant Dis. 81:4-12.
3. Yoo, D. S., B. S. Lee and E. K. Kim. 2005. Characteristics of microbial biosurfactant as an antifungal agent against plant pathogenic fungus. J. Microbiol. Biotechnol. 15(6):1164-1169.
4. Bisht, K. S., R. A. Gross and D. L. Kaplan. 1999. Enzyme-mediated regioselective acylations of sophorolipids. J. Org. Chem. 64:780-789.
5. Trummler, K., Effenberger, F., Syldatk, C. 2003. An integrated microbial/enzymatic process for production of rhamnolipids and L-(+)-rhamnose from rapeseed oil with Pseudomonas sp. DSM 2874. Eur. J. Lipid Sci. Technol. 105, 563-571.
6. Marchal, R., Lemal, J., Sulzer, C. 1997. Method of production of sophorosides by fermentation with fed batch supply of fatty acid esters or oils, U.S. Pat. No. 5,616,479.
7. US patent application No. 200S/0266036 Al. Microbial biosurfactants as agents for controlling pests.
8. Davila, A. M., R. Marchal, N. Monin, Vandecasteele, J. P. 1993. Identification and determination of individual sophorolipids in fermentation products by gradient elution high-performance liquid chromatography with evaporative light-scattering detection. Journal of Chromatography, 648, 139-149
9. Asmer, H., Lang, S., Wagner, F., Wray, V. 1988. Microbial production, structure elucidation and bioconversion of sophorose lipids. J. Am. Oil Chem. Soc. 65, 1460-1466
10. Tulloch, A. P., Spencer, J. F. T., Gorin, P. A. J. 1962. Fermentation of long-chain compounds by Torulopsis magnoliae. I. Structures of the hydroxy fatty acids obtained by the fermentation of fatty acids and hydrocarbons. Can. J. Chem. 40, 1326-1338.
11. Zhou, Q. H., Klekner, V., Kosaric, N. 1992. Production of sophorose lipids by Torulopsis bombicola from safflower oil and glucose. J. Am. Oil Chem. Soc. 69, 89-91.
12. Zhou Q-H, Kosaric, N. 1995. Utilization of canola oil and lactose to produce biosurfactant with Candida bombicola. J. Am. Oil. Chem. Soc. 72, 67-71
13. Rau, U., Heckmann, R., Wray, V., Lang, S. 1999. Enzymatic conversion of a sophorolipid into a glucose lipid. Biotechnol. Lett. 21, 973-977
14. Felse, P. A., Shah, V., Chan, J., Rao, K. J., Gross, R. A. 2007. Sophorolipid biosynthesis by Candida bombicola from industrial fatty acid residues. Enzyme and Microbial Technology 40, 316-323.
15. Mueller, C. M., Viterbo, D., Murray, P. J., Shah, V.; Gross, R., Schulze, R., Zenilman, M. E., Bluth, M. H. 2006. Sophorolipid treatment decreases inflammatory cytokine expression in an in vitro model of experimental sepsis. Faseb Journal 20 (4); A204-A204 Part 1.
16. Shah, V., Doncel, G. F., Seyoum, T., Eaton, K. M., Zalenskaya, I., Hagver, R., Azim, A., Gross, R. A., 2005. Sophorolipids, microbial glycolipids with anti-human Immunodeficiency virus and sperm-immobilizing activities. Antimicrobial Agents and Chemotherapy 49, 4093-4100.
17. Zhang, L., Somasundaran, P., Singh, S. K., Felse, A. P., Gross, R. A. 2004. Synthesis and interfacial properties of sophorolipid derivatives.” Colloids and Surfaces A: Physicochem. Eng. Aspects 240, 75-82.
18. Hagler, M., Smith-Norowitz, T. A., Chice, S., Wallner, S. R., Viterbo, D., Mueller, C. M. Gross, R.; Nowakowski, M.; Schulze, R.; Zenilman, M. E.; Bluth, M. H. 2007. Sophorolipids decrease IgE production in U266 cells by downregulation of BSAP (Pax5), TLR-2, STAT3 and IL-6. Journal of Allergy and Clinical Immunology, 119 (1), S263-S263
19. B. M. Irish, J. C. Correll and Morelock, T. E. 2002. The effect of synthetic surfactants on disease severity of white rust on spinach Plant Disease (2002) 86, 791-796.

What is claimed is:

1. A method for controlling, inhibiting the growth of, or killing live cells and/or spores, comprising:
a) providing an admixture of compounds that consist of at least two constituents selected from the group consisting of natural sophorolipids, natural sophorolipid mixture, and modified sophorolipids; and
b) applying the admixture to undesirable microbial cells, plants, surface, device, or any system containing undesirable microbes, live cells, and/or spores that have grown or might grow,
whereby the admixture controls, inhibits the growth of, or kills the live cells and/or spores.

2. The method of claim 1 where the microbe is selected from the group consisting of plant pathogens, human pathogens, microbes, or combination of microbes.

3. The method of claim 2, wherein the microbe is a microbe grows on surfaces causing fouling or contamination of that surface.

4. The method of claim 3, wherein the microbe has accumulated in excess due to some shift in an ecosystem selected from the group consisting of a non-natural chemical in lakes, catheters, medical dives, walls, shower curtains, shower rooms, swimming pools, pipelines, water filters, cooling towers, marine structures, ships, boats, navigational aids, channel markers, buoys, oil exploration plat forms, oil wells, oil pipelines, and surface of equipment.

5. The method of claim 1, wherein the modified sophorolipids are synthesized by methods using natural sophorolipids produced by fermentation from a feedstock mixture, wherein the fatty acid is selected from the group consisting of tallow, sunflower oil, rapeseed oil, safflower oil, soya bean oil, palm oil, coconut oil, olive oil, and short-chain to medium chain length carboxylic acid having an alkyl chain length from 6 to 22 carbons.

6. The method of claim 1, wherein the microbe is selected from live cells or spores selected from the group consisting of bacteria, fungi, viruses, algae, and protozoan.

7. The method of claim 1, wherein the microbes are those that form biofilms that contaminate surfaces.

8. The method of claim 1, wherein the modified sophorolipids are obtained without purifying a reaction mixture used to form the modified sophorolipids or pure compounds of the modified sophorolipids.

9. The method of claim 1, wherein the modified sophorolipids are obtained from sophorolipid mixtures of different purity with varying contents of natural to open chain sophorolipids.

10. The method of claim 1, wherein the admixture consists of two modified sophorolipids compounds of different compositions.

11. The method of claim 1, wherein the admixture consists of mixing at least two modified sophorolipids of different compositions.

12. The method of claim 1, wherein the admixture consists of mixing one modified sophorolipid and at least one natural sophorolipid component.

13. The method of claim 1, wherein the admixture consists of mixing one modified sophorolipid and a natural sophorolipid mixture.

14. The method of claim 1, wherein the admixture consists of mixing at least one modified sophorolipid and a least one natural sophorolipid component.

15. The method of claim 1, wherein the admixture acts synergistically to increase the antimicrobial activity relative to any of the components in the mixture tested alone.

16. The method of claim 1, wherein the admixture is applied as a solution that is a concentrate or at an appropriate concentration for use.

17. The method of claim 1, wherein the admixture is in powder form and is applied as a powder or dissolved in a solution prior to application.

18. The method of claim 1, wherein the admixture acts synergistically in a ratio wherein the component with the lowest concentration is 1:200^{th} (w/w) of the summation of the other components and the component of the admixture that is in the highest concentration is up to 30 times greater than the summation of the other components.

19. The method of claim 1, wherein the admixture consists of at least one modified sophorolipid or at least one modified sophorolipid in combination with a natural sophorolipid component and/or natural sophorolipid mixture further comprises chemical or biobased emulsifiers, biosurfactants, surfactants, and eco-friendly organic solvents used in pesticides, antimicrobial agent(s), disinfectant(s), personnel hygienic agents and cosmetics.

20. The method of claim 1, wherein the admixture consists of at least one modified sophorolipid or at least one modified sophorolipid in combination with a natural sophorolipid component and/or natural sophorolipid mixture further comprises inert ingredients used in the formulation of pesticides, biopesticides, biochemical pesticides and antimicrobial agents, disinfectants, personnel hygienic agents and cosmetics such as adjuvants, buffering agents or pH adjusting agents/salts and solublizers.

21. The method of claim 19, wherein the admixture has a physical form of selected from the group consisting of wettable powder, powders, dust, granules, liquids, gels, semisolids, colloidal materials, paste, incorporated in wipes, papers, and polymers to form a pesticide, biopesticide, biochemical pesticide, antimicrobial agent, disinfectant, personnel hygienic agent, or cosmetic.

22. The method of claim 20, wherein the admixture has a physical form of selected from the group consisting of wettable powder, powders, dust, granules, liquids, gels, semisolids, colloidal materials, paste, incorporated in wipes, papers, and polymers to form a pesticide, biopesticide, biochemical pesticide, antimicrobial agent, disinfectant, personnel hygienic agent, or cosmetic.

23. The method of claim 20, wherein the admixture further comprises a member of the group of components selected from the group consisting of cinnamon oil, clove oil, cottonseed oil, garlic oil, or rosemary oil, natural biosurfactants, synthetic surfactants, aldehydes, almond oil, camphor oil, castor oil, cedar oil, citronella oil, citrus oil, coconut oil, corn oil, eucalyptus oil, fish oil, geranium oil, lecithin, lemon grass oil, linseed oil, mineral oil, mint or peppermint oil, olive oil, pine oil, rapeseed oil, safflower oil, sage oils, sesame seed oil, sweet orange oil, thyme oil, vegetable oil, and wintergreen oil, adjuvants, surfactants, emulsifying agents, plant nutrients, fillers, plasticizers, lubricants, glidants, colorants, pigments, bittering agents, buffering agents, solubility controlling agents, pH adjusting agents, preservatives, stabilizers and ultra-violet light resistant agents, stiffening agents, and hardening agents.

24. The method of claim 20, wherein the buffering agents are selected from the group consisting of organic and amino acids or their salts, citrate, gluconate, tartrate, malate, acetate, lactate, oxalate, aspartate, malonate, glucoheptonate, pyruvate, galactarate, glucarate, tartronate, glutamate, glycine, lysine, glutamine, methionine, cysteine, arginine, and mixtures thereof; phosphoric and phosphorous acids or their salts; and synthetic buffers selected from the group consisting of organic and amino acids or their salts.

25. The method of claim 20, further comprising solubility control agents or excipients selected from the group consisting of wax, chitin, chitosan, C12-C20 fatty acids such as myristic acid, stearic acid, palmitic acid; C12-C20 alcohols such as lauryl alcohol, cetyl alcohol, myristyl alcohol, and stearyl alcohol; amphiphilic esters of fatty acids with glycerol, such as monoesters C12-C20 fatty acids such as glyceryl monolaurate, glyceryl monopalmitate; glycol esters of fatty acids such polyethylene glycol monostearate or polypropylenemonopalmitate glycols; C12-C20 amines such lauryl amine, myristyl amine, stearyl amine, and amides of C12-C20 fatty acids; to control the release of the active substances.

26. The method of claim 20, wherein the pH adjusting agents are selected from the group consisting of potassium hydroxide, ammonium hydroxide, potassium carbonate or bicarbonate, hydrochloric acid, nitric acid, sulfuric acid, and mixtures thereof.

27. The method of claim 20, further comprising polyprotic acids, such as sodium bicarbonate, sodium carbonate, sodium sulfate, sodium phosphate, sodium biphosphate, when forming aqueous preparation formulations.

28. The method of claim 19, wherein the surfactant is selected from the group consisting of alkyl betaines, alkyl sulfates, alkyl ammonium bromide derivatives, alkyl phenol ethoxylates, alkyl ethylene or polyethylene ethoxylates, alkyl or acyl glycosides, tween 80, tween 60, tween 40, tween 20, polypropylene glycol, and biosurfactants.

29. The method of claim 19, wherein the biosurfactant is selected from the group consisting of rhamnolipids, mannosylerythritol, cellobiose lipids, trehalose lipids, emulsan, lipopeptides, surfactin, lipoproteins, lipopolysaccharide-protein complexes, phospholipids, and polysaccharide-protein-fatty acid complexes and any other compound(s) with potential uses as a biosurfactant.

30. The method of claim 19, wherein the biosurfactants or surface active compounds are pure, crude, or directly collected from culture broth or the culture broth having surface active agents in it.

31. The method of claim 19, wherein the admixture is applied by spraying, pouring, dipping, in the form of concentrated or diluted liquids, solutions, suspensions, powders, incorporated in wipes, papers, and polymers, containing such concentrations of the active agent as is most suited for a particular purpose and application.

32. The method of claim 19, wherein the admixture is formulated into solid formulations selected from the group consisting of cylinders, rods, blocks, capsules, tablets, pills, pellets, strips, and spikes; and wherein the solid formulations can be milled, granulated or powdered; and wherein the granulated or powdered material can be pressed into tablets or used to fill pre-manufactured gelatin capsules or shells; and wherein semi solid formulations can be prepared in paste, wax, gel, or cream preparations.

33. The method of claim 19, wherein the admixture is used for human or animal applications.

34. The method of claim 33, wherein the admixture is prepared in liquid, paste, ointment, suppository, capsule or tablet forms and used in a way similar to drugs used in the medicinal drugs industry.

35. The method of claim 33, wherein the admixture is encapsulated using components known in the pharmaceutical industry so as to protect the components from undesirable reactions and help the ingredients resist adverse conditions in the environment or the treated object or body.

36. The method of claim 19, wherein the admixture is applied to plants, pests, or soil using various methods of application depending on certain circumstances.

37. The method of claim 36, wherein admixture is introduced directly in the soil in the vicinity of plant roots.

38. The method of claim 37, wherein the admixture is in the form of liquid, bait, powder, dusting, or granules, or the admixture is inserted in the soil as tablets, spikes, rods, or other shaped moldings.

39. The method of claim 36, wherein the admixture is formulated and used for treating individual plant, tree, plants or trees.

40. The method of claim 39, wherein the admixture is molded into different shapes or forms and introduced into the vascular tissue of the plants.

41. The method of claim 40, wherein the molding forms are selected from the group consisting of tablets, capsules, plugs, rods, spikes, films, strips, nails, or plates; and wherein the shaped molding forms are introduced into pre-drilled holes into the plants or root flares, or pushed or punched into the cambium layer.

42. The method of claim 39, wherein the admixture, after formulation, is applied by the use of dispensing devices such as syringes, pumps or caulk guns, paste-tubes or plunger tubes for delivering semi-solid formulations (paste, gel, cream) into drilled holes in tree trunks or root flares.

43. The method of claim 39, wherein the admixture, after formulation, is applied in the form of paste, gel, coatings, strips, or plasters onto the surface of the plant; wherein a plaster or strip may be in a semi-solid formulation, e.g., insecticide placed on the side that will contact the tree, bush, or rose during the treatment; and wherein the same strip may have glue or adhesive at one or both ends to wrap around or stick to the subject being treated.

44. The method of claim 39, wherein the admixture, after formulation, is sprayed or dusted on the leaves in the form of pellets, spray solution, granules, or dust.

45. The method of claim 19, wherein the admixture, after formulation, are solid or semi-solid compositions that are coated using film-coating compounds used in the pharmaceutical industry such as polyethylene glycol, gelatin, sorbitol, gum, sugar or polyvinyl alcohol.

46. The method of claim 45, further comprising a bittering agent such as denatonium benzoate or quassin may also be incorporated in the admixture, a coating, or both.

47. The method of claim 19, wherein concentrations of ingredients in the admixture and application rate of the admixtures is varied depending on the pest, plant, animal, human, microbes or area treated, or method of application.

48. The method of claim 47, wherein the admixture is used to control a variety of pests, microbes, insects, invertebrates, algae, weeds, and other plants.

49. The method as defined in claim 1, wherein the modified sophorolipid derivatives are used as activity enhancers in antimicrobial formulations for other antimicrobial agents.
